(19) United States
(12) Patent Application Publication
(10) Pub. No.: US 2013/0189577 A1
(43) Pub. Date: Jul. 25, 2013

(54) APPARATUS AND METHOD FOR HOT COATING ELECTRODES OF LITHIUM-ION BATTERIES

(71) Applicants: Zheng WANG, Mountain View, CA (US); Victor PEBENITO, San Jose, CA (US); Connie P. WANG, Mountain View, CA (US); Robert Z. BACHRACH, Burlingame, CA (US)

(72) Inventors: Zheng WANG, Mountain View, CA (US); Victor PEBENITO, San Jose, CA (US); Connie P. WANG, Mountain View, CA (US); Robert Z. BACHRACH, Burlingame, CA (US)

(21) Appl. No.: 13/717,076

(22) Filed: Dec. 17, 2012

Related U.S. Application Data
(60) Provisional application No. 61/578,154, filed on Dec. 20, 2011.

(51) Int. Cl. H01M 4/131; H01M 4/1391

(52) U.S. Cl. CPC H01M 4/131; H01M 4/1391
USPC 429/211; 118/58; 118/642; 118/621

(57) ABSTRACT

A method and apparatus for fabricating high-capacity energy storage devices is provided. In one embodiment, a deposition system for manufacturing energy storage electrodes is provided. The deposition system comprises a transfer mechanism for transferring a substrate, an active material supplying assembly for depositing an electro-active powder mixture onto the substrate, and a heat source for drying the as-deposited electro-active powder mixture.

### CROSS-REFERENCE TO RELATED APPLICATIONS

This application claims benefit of U.S. provisional patent application Ser. No. 61/578,154, filed Dec. 20, 2011 which is herein incorporated by reference in its entirety.

### GOVERNMENT RIGHTS IN THIS INVENTION

This invention was made with Government support under DE-AR0000063 awarded by DOE. The Government has certain rights in this invention.

### BACKGROUND OF THE INVENTION

1. Field of the Invention

Embodiments of the present invention relate generally to high-capacity energy storage devices and methods and apparatus for fabricating high-capacity energy storage devices.

2. Description of the Related Art

Fast-charging, high-capacity energy storage devices, such as supercapacitors and lithium-ion (Li-ion) batteries, are used in a growing number of applications, including portable electronics, medical, transportation, grid-connected large energy storage, renewable energy storage, and uninterruptible power supply (UPS).

Contemporary, secondary and rechargeable energy storage devices typically include an anode electrode, a cathode electrode, a separator positioned between the anode electrode and the cathode electrode, and at least one current collector. The current collector component of the electrodes is generally made of a metal foil. Examples of materials for the positive current collector (the cathode) typically include aluminum (Al), stainless steel (SST), and nickel (Ni). Examples of materials for the negative current collector (the anode) typically include copper (Cu), but stainless steel (SST), and nickel (Ni) may also be used.

The active positive cathode electrode material of a Li-ion battery is typically selected from a wide range of lithium transition metal oxides. Examples include oxides with spinel structures (LiMn₂O₄ (LMO), LiNi_{0.5}Mn_{1.5}O₄ (LMNO), etc.), layered structures (LiCoO₂, nickel-manganese-cobalt (NMC), nickel-cobalt-aluminum (NCA), etc.), olivine structures (LiFePO₄, etc.), and combinations thereof. Pre-formed cathode electrode materials are typically expensive. The particles may be mixed with conductive particles, such as nanocarbon (carbon black, etc.) and graphite, and a binding agent.

The active negative anode electrode material is generally carbon based, either graphite or hard carbon, with particle sizes around 5-15 um. Silicon (Si) and tin (Sn)-based active materials are currently being developed as next generation anode materials. Both have significantly higher capacity than carbon based electrodes. Li₁₅Si₄ has a capacity of about 3,580 mAh/g, whereas graphite has a capacity less than 372 mAh/g. Sn-based anodes can achieve capacities over 900 mAh/g which are much higher than next generation cathode materials can achieve. Thus, it is expected that cathodes will continue to be thicker than anodes.

Currently, the active materials only account for <50 wt % of the overall components of battery cells. The ability to manufacture thicker electrodes containing more active materials would significantly reduce the production costs for battery cells by reducing the percentage contribution from inactive elements. However, the thickness of electrodes is currently limited by both the utilization and the mechanical properties of the materials currently used.

One method for manufacturing energy storage devices is principally based on slit coating of viscous powder slurry mixtures of cathodically or anodically active material onto a conductive current collector followed by prolonged heating to form a dried cast sheet and prevent cracking. The thickness of the electrode after drying which evaporates the solvents is finally determined by compression or calendering which adjusts the density and porosity of the final layer. Slit coating of viscous slurries is a highly developed manufacturing technology which is very dependent on the formulation, formation, and homogenation of the slurry. The formed active layer is extremely sensitive to the rate and thermal details of the drying process.

Among other problems and limitations of this technology is the slow and costly drying component which requires both a large footprint (e.g., up to 50 meters long).

Accordingly, there is a need in the art for faster charging, higher capacity energy storage devices that are smaller, lighter, and can be more cost effectively manufactured at a high production rate.

### SUMMARY OF THE INVENTION

Embodiments of the present invention relate generally to high-capacity energy storage devices and methods for fabricating high-capacity energy storage devices. In one embodiment, a deposition system for manufacturing energy storage electrodes is provided. The deposition system comprises a transfer mechanism for transferring a substrate, an active material supplying assembly having multiple dispensing assemblies for simultaneously depositing a plurality of different electrode forming materials onto the substrate from an electrode forming mixture, and a heat source for simultaneously drying the electrode forming mixture as the electrode forming mixture is deposited onto the substrate.

In another embodiment an electrode structure is provided. The electrode structure comprises a current collector and a plurality of multifunctional electrode layers vertically positioned relative to the current collector, wherein a portion of each of the multifunctional electrode layers contacts the current collector.

In yet another embodiment, an electrode structure is provided. The electrode structure comprises a current collector and a plurality of multifunctional electrode layers horizontally positioned relative to the current collector.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a schematic diagram of a partial battery cell bi-layer having one or more electrode structures formed according to embodiments described herein;

FIG. 1B is a schematic diagram of a partial battery cell having one or more electrode structures formed according to embodiments described herein;

FIG. 2A is a schematic diagram of one embodiment of an electrode structure formed according to embodiments described herein;

FIG. 2B is a schematic diagram of another embodiment of an electrode structure formed according to embodiments described herein;

FIG. 3 is a schematic cross-sectional side view of one embodiment of a portion of a deposition system according to embodiments described herein;

FIG. 4 is a schematic representation of a scanning electron microscope (SEM) image of one embodiment of cathode material deposited according to the embodiments described herein; and

FIG. 5A is a plot depicting simulated drying time for cathode materials having a thickness of 100 microns and 200 microns deposited in the presence of low flow rate air on the coating surface; and

FIG. 5B is a plot depicting simulated drying time for cathode materials having a thickness of 100 microns and 200 microns deposited in the presence of high flow rate air on the coating surface.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the present invention relate generally to high-capacity energy storage devices and methods and apparatus for fabricating high-capacity energy storage devices. Current electrode coaters adopt large dimension space for coating and post-coating drying processes due to the difficulty in scaling up drying speed. Due to the large drying component, the coater typically has the longest footprint among the manufacturing tools. Certain embodiments described herein provide for a deposition system with the ability to simultaneously deposit material and dry the material as it is deposited. This ability to simultaneously coat and dry allows for a significantly smaller footprint than current coaters and driers. In certain embodiments described herein, current collectors (typically copper or aluminum) are heated to certain temperatures with or without the presence of hot air flow over the surface of the current collector. In certain embodiments, electrode forming slurries may be pre-heated prior to deposition. In certain embodiments, drying agents may be included in the electrode forming slurry to increase the rate of drying.

As used herein, the term “vertical” is defined as a major surface of a structure being perpendicular to the horizon.

As used herein, the term “horizontal” is defined as a major surface of a structure being parallel to the horizon.

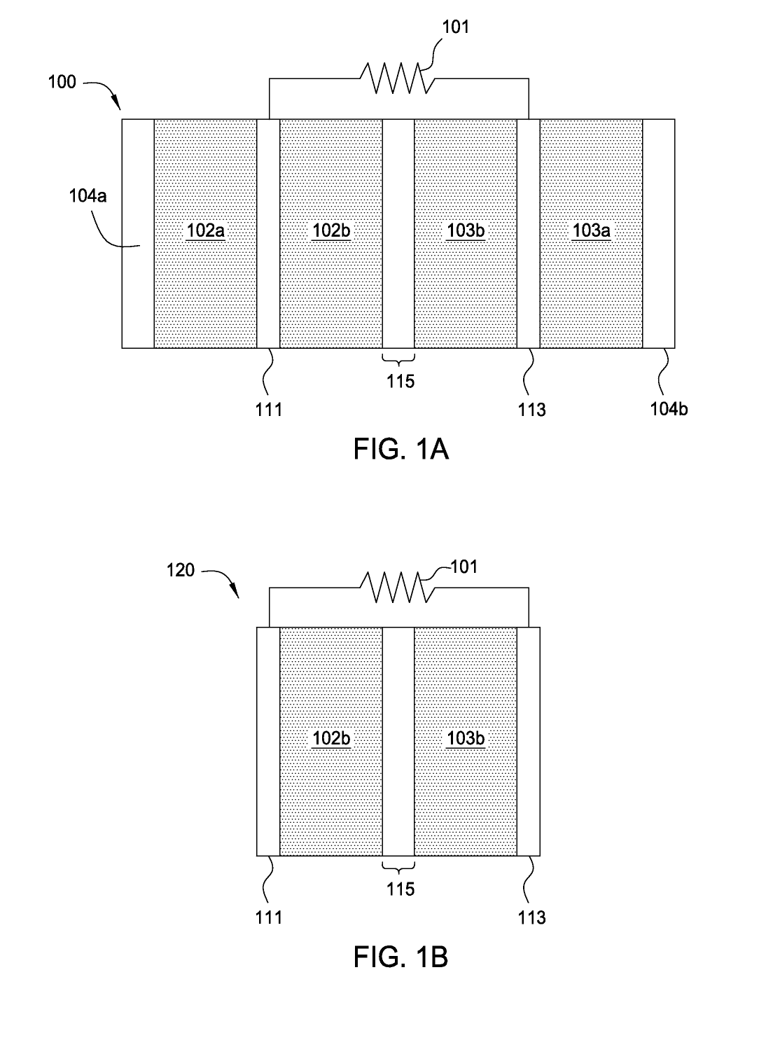

FIG. 1A is a schematic diagram of a partial battery cell bi-layer 100 having one or more electrode structures (anode 102a, 102b and/or cathode 103a, 103b) formed according to embodiments described herein. The partial battery cell bi-layer 100 may be a Li-ion battery cell bi-layer. FIG. 1B is a schematic diagram of a partial battery cell 120 having one or more electrode structures formed according to embodiments described herein. The partial battery cell bi-layer 120 may be a Li-ion battery cell bi-layer. The battery cells 100, 120 are electrically connected to a load 101 according to one embodiment described herein. The primary functional components of the battery cell bi-layer 100 include anode structures 102a, 102b, cathode structures 103a, 103b, separator layers 104a, 104b, and 115, current collectors 111 and 113 and optionally an electrolyte (not shown) disposed within the region between the separator layers 104a, 104b. The primary functional components of the battery cell 120 include anode structure 102b, cathode structure 103b, the separator 115, current collectors 111 and 113 and an optional electrolyte (not shown) disposed within the region between the current collectors 111, 113. A variety of materials may be used as the electrolyte, for example, a lithium salt in an organic solvent. The battery cells 100, 120 may be hermetically sealed in a suitable package with leads for the current collectors 111 and 113.

The anode structures 102a, 102b, cathode structures 103a, 103b, and separator layers 104a, 104b and 115 may be immersed in the electrolyte in the region formed between the separator layers 104a and 104b. It should be understood that a partial exemplary structure is shown and that in certain embodiments, additional anode structures, cathode structures, and current collectors may be added to the structure.

Anode structure 102b and cathode structure 103b serve as a half-cell of the battery 100. Anode structure 102b may include a metal anodic current collector 111 and an active material formed according to embodiments described herein. The anode structure may be porous. Other exemplary active materials include graphitic carbon, lithium, tin, silicon, aluminum, antimony, SnBₓCo_{y}O₃, and LiₓCo_{y}N. Similarly, cathode structure 103b may include a cathodic current collector 113 respectively and a second active material formed according to embodiments described herein. The current collectors 111 and 113 are made of electrically conductive material such as metals. In one embodiment, the anodic current collector 111 comprises copper and the cathodic current collector 113 comprises aluminum. The separator 115 is used to prevent direct electrical contact between the components in the anode structure 102b and the cathode structure 103b. The separator 115 may be porous.

Active materials on the cathode side of the battery cell 100, 120 or positive electrode, may comprise a lithium-containing metal oxide, such as lithium cobalt dioxide (LiCoO₂) or lithium manganese dioxide (LiMnO₂), LiCoO₂, LiNiO₂, LiNiₓCo_{y}O₂, LiNiₓCo_{y}Al_{z}O₂, LiMn₂O₄, LiₓMg_{y}Mn_{z}O₄, LiNiₓMn_{y}O₂, LiNiₓMn_{y}Co_{z}O₂, LiAlₓMn_{y}O₄ and LiFePO₄. The active materials may be made from a layered oxide, such as lithium cobalt oxide, an olivine, such as lithium iron phosphate, or a spinel, such as lithium manganese oxide. In non-lithium embodiments, an exemplary cathode may be made from TiS₂ (titanium disulfide). Exemplary lithium-containing oxides may be layered, such as lithium cobalt oxide (LiCoO₂), or mixed metal oxides, such as LiNiₓCo₁₋₂ₓMnO₂, LiNi_{0.5}Mn_{1.5}O₄, Li(Ni_{0.8}Co_{0.15}Al_{0.05})O₂, LiMn₂O₄. Exemplary phosphates may be iron olivine (LiFePO₄) and it is variants (such as LiFe₁₋ₓMgPO₄), LiMoPO₄, LiCoPO₄, LiNiPO₄, Li₃V₂(PO₄)₃, LiVOPO₄, LiMP₂O₇, or LiFe_{1.5}P₂O₇. Exemplary fluorophosphates may be LiVPO₄F, LiAlPO₄F, Li₅V(PO₄)₂F₂, Li₅Cr(PO₄)₂F₂, Li₂CoPO₄F, or Li₂NiPO₄F. Exemplary silicates may be Li₂FeSiO₄, Li₂MnSiO₄, or Li₂VOSiO₄. An exemplary non-lithium compound is Na₅V₂(PO₄)₂F₃.

Active materials on the anode side or negative electrode of the battery cell 100, 120, may be made from materials such as, for example, graphitic materials and/or various fine powders, for example, microscale or nanoscale sized powders. Additionally, silicon, tin, or lithium titanate (Li₄Ti₅O₁₂) may be used with, or instead of, graphitic materials to provide the conductive core anode material. Exemplary cathode materials, anode materials, and methods of application are further described in commonly assigned United States Patent Application Publication No. US 2011/0129732, filed Jul. 19, 2010 titled COMPRESSED POWDER 3D BATTERY ELECTRODE MANUFACTURING, and commonly assigned United States Patent Application Publication No. US 2011/0168550, filed Jan. 13, 2010, titled GRADED ELECTRODE TECHNOLOGIES FOR HIGH ENERGY LITHIUM-ION BATTERIES, both of which are herein incorporated by reference in their entirety.

It should also be understood that although a battery cell bi-layer 100 is depicted in FIGS. 1A and 1B, the embodiments described herein are not limited to Li-ion battery cell bi-layer structures. It should also be understood, that the anode and cathode structures may be connected either in series or in parallel.

Electrode Formation

The electrode structure may be formed from an electrode forming solution. The electrode forming solution may comprise at least one of the following: an electro-active material, a binding agent, electro-conductive material and a drying agent.

Exemplary electro-active materials which may be deposited using the embodiments described herein include but are not limited to cathodically active particles selected from the group comprising lithium cobalt dioxide (LiCoO₂), lithium manganese dioxide (LiMnO₂), titanium disulfide (TiS₂), LiNixCo₁₋₂ₓMnO₂, LiMn₂O₄, iron olivine (LiFePO₄) and it is variants (such as LiFe₁₋ₓMgPO₄), LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, other qualified powders, composites thereof and combinations thereof.

Other exemplary electro-active materials which may be deposited using the embodiments described herein include but are not limited to anodically active particles selected from the group comprising graphite, graphene hard carbon, carbon black, carbon coated silicon, tin particles, copper-tin particles, tin oxide, silicon carbide, silicon (amorphous or crystalline), silicon alloys, doped silicon, lithium titanate, any other appropriately electro-active powder, composites thereof and combinations thereof.

Exemplary drying agents include isopropyl alcohol, methanol, and acetone.

Exemplary binding agents include, but are not limited to, polyvinylidene difluoride (PVDF) and water-soluble binding agents, such as styrene butadiene rubber (SBR) and sodium carboxymethyl cellulose (CMC).

Exemplary electro-conductive materials include, but are not limited to, carbon black (“CB”) and acetylene black (“AB”).

The electrode forming solution may have a solids content of between about 30 wt. % and about 80 wt. %. The electrode forming solution may have a solids content of between about 40 wt. % and about 70 wt. %. The electrode forming solution may have a solids content of between about 50 wt. % and about 60 wt. %.

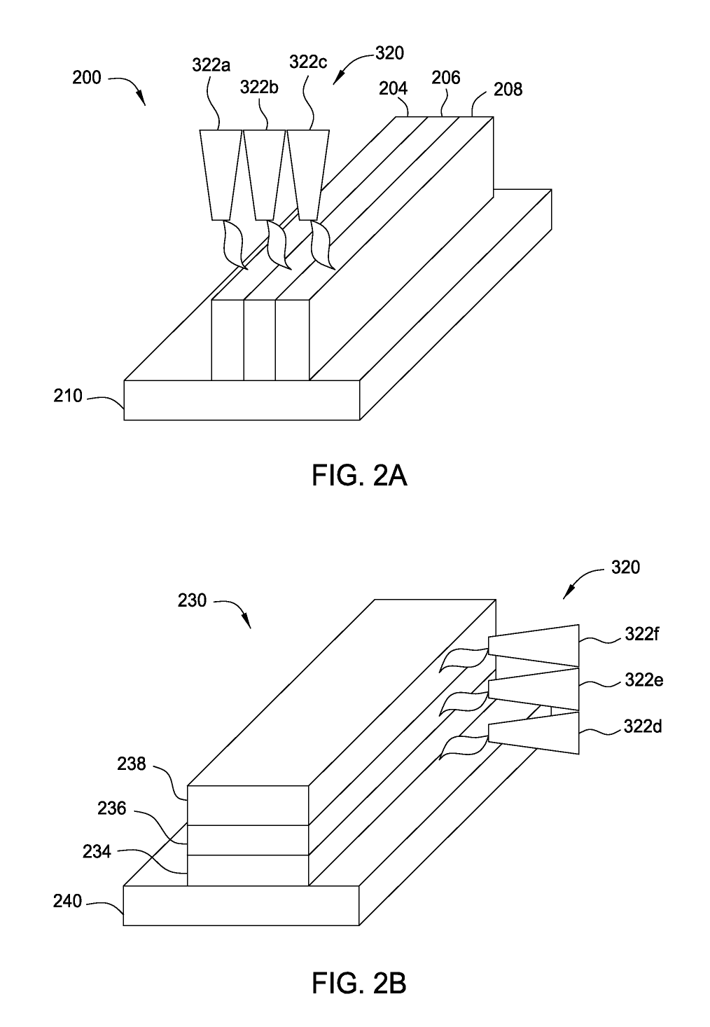

FIG. 2A is a schematic diagram of one embodiment of an electrode structure 200 formed according to embodiments described herein. The electrode structure 200 may be a cathode structure or an anode structure. The electrode structure 200 may be used as the anode structures 102a, 102b and/or cathode structures 103a, 103b of the battery cells 100, 120.

The electrode structure 200 comprises a plurality of multifunctional electrode layers 204, 206, 208 positioned on a current collector 210. The current collector 210 may be similar to current collectors 111, 113. As depicted in FIG. 2A, each of the three electrode layers 204, 206, 208 are vertically positioned relative to the current collector 210. A portion of each of the three electrode layers 204, 206, 208 may contact the current collector 210 as shown in FIG. 2A. The electrode layers 204, 206, 208 may be simultaneously deposited on the current collector 210. The electrode layers 204, 206, 208 may be simultaneously or sequentially deposited using an active material supplying assembly 320 comprising multiple dispensing nozzles 322a, 322b, 322c. The active material dispensing nozzles 322a, 322b, 322c may be positioned in parallel across the width of the current collector 210. Although only three layers 204, 206, 208 are shown, any number of electrode layers may be used dependent upon the desired properties of the electrode structure 200.

Each of the multifunctional electrode layers 204, 206, 208 may vary from at least one other multifunctional layer in at least one of the following characteristics: materials, compositions/ingredient ratios, particle size, conductivity, porosity, and energy/power grades. For example, if each multifunctional electrode layer 204, 206, 208 has a different porosity relative to at least one other multifunctional electrode layers, the electrode structure 200 has a vertical porosity gradient. In certain embodiments, the porosity may be highest in electrode layer 204 and decrease through layers 206 and 208. The porosity may be lowest in electrode layer 204 and increase through layers 206 and 208.

The multifunctional electrode layers 204, 206, 208 may be applied by powder application techniques including but not limited to sifting techniques, electrostatic spraying techniques, thermal or flame spraying techniques, fluidized bed coating techniques, slit coating techniques, roll coating techniques, nanoprinting, extrusion, three dimensional printing “3DP” (e.g., drop-on-demand inkjet printing) and combinations thereof, all of which are known to those skilled in the art.

FIG. 2B is a schematic diagram of another embodiment of an electrode structure 230 formed according to embodiments described herein. The electrode structure 230 may be a cathode structure or an anode structure. The electrode structure 230 may be used as the anode structures 102a, 102b and/or cathode structures 103a, 103b of the battery cells 100, 120.

Similar to the electrode structure 200, the electrode structure 230 comprises a plurality of multifunctional electrode layers or segments 234, 236, 238 positioned on a current collector 240. The current collector 240 may be similar to current collectors 111, 113. As depicted in FIG. 2B, each of the three electrode layers 234, 236, 238 are horizontally positioned relative to the current collector 240. The electrode layer 234 is the only electrode layer that contacts the current collector 240. The electrode layers 234, 236, 238 may be simultaneously deposited. The electrode layers 234, 236, 238 may be simultaneously or sequentially deposited using an active material supplying assembly 320 comprising dispensing nozzles 322d, 322e, 322f. The active material dispensing nozzles 322d, 322e, 322f may be positioned in parallel. Although only three layers 234, 236, 238 are shown, any number of electrode layers may be used dependent upon the desired properties of the electrode structure 200.

As discussed with relation to the electrode structure 230 depicted in FIG. 2A, each of the multifunctional electrode layers 234, 236, 238 may vary from at least one of the other multifunctional electrode layers in at least one of the following characteristics: materials, compositions/ingredient ratios, particle size, conductivity, porosity, and energy/power grades. For example, if each multifunctional electrode layer 234, 236, 238 has a different porosity relative to at least one other multifunctional electrode layers, the electrode structure 230 has a horizontal porosity gradient. The porosity may be highest in electrode layer 234 and decrease through layers 236 and 238. The porosity may be lowest in electrode layer 234 and increase through layers 236 and 238.

The multifunctional electrode layers 234, 236, 238 may be applied by techniques including but not limited to sifting techniques, electrostatic spraying techniques, thermal or flame spraying techniques, fluidized bed coating techniques, slit coating techniques, roll coating techniques, inkjet printing, three dimensional printing and combinations thereof, all of which are known to those skilled in the art.

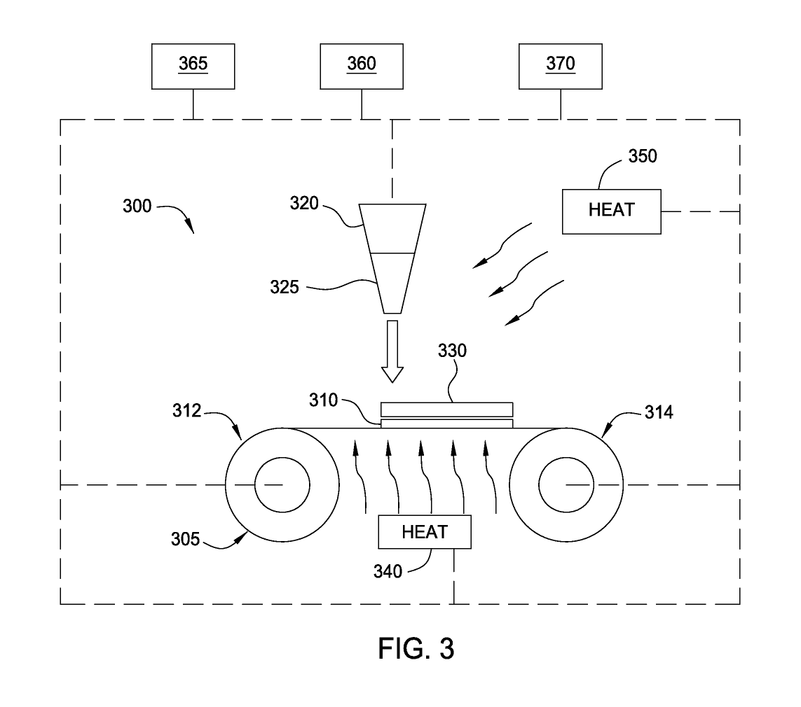

FIG. 3 is a schematic cross-sectional side view of one embodiment of a portion of a deposition system 300 according to embodiments described herein. The deposition system 300 may comprise a transfer mechanism 305 for transferring a substrate 310, an active material supplying assembly 320 for supplying an electrode forming solution 325 and depositing an electro-active material 330 onto the substrate 310, a first optional heat source 340 positioned below the substrate 310 for drying the as-deposited electro-active material 330, a second optional heat source 350 positioned above the substrate 310 for drying the as-deposited electro-active material. The electrode forming solution 325 may be heated prior to deposition.

The first optional heat source 340 and the second optional heat source 350 may be individually configured to perform a drying process such as an air drying process, an infrared drying process or an electromagnetic drying process. The second heat source 350 may be positioned to blow heated air or inert gases onto the substrate 310. The second heat source 350 may be positioned to blow air or inert gases onto the substrate 310 prior to, during, and/or after deposition of electro-active material 310 onto the substrate 310. The air or inert gases may be heated.

The transfer mechanism 305 may comprise any transfer mechanism capable of moving the substrate 310 through the processing region of the deposition system 300. The transfer mechanism 305 may comprise a common transport architecture. The common transport architecture may comprise a roll-to-roll system with a common take-up-roll 312 and feed roll 314 for the system. The take-up roll 312 and the feed roll 314 may be individually heated. The take-up roll 312 and the feed roll 314 may be individually heated using an internal heat source positioned within each roll or an external heat source. The common transport architecture may further comprise one or more intermediate transfer rollers positioned between the take-up roll 312 and the feed roll 314. Although the deposition system 300 is depicted as having a single processing region, in certain embodiments, it may be advantageous to have separate or discrete processing regions or chambers for each process step. For embodiments having discrete processing regions or chambers, the common transport architecture may be a roll-to-roll system where each chamber or processing region has an individual take-up-roll and feed roll and one or more optional intermediate transfer rollers positioned between the take-up roll and the feed roll. The common transport architecture may comprise a track system which extends through the processing region or discrete processing regions and is configured to transport either a web substrate or discrete substrates.

In certain embodiments where at least one of the take-up roll 312 and the feed roll 314 are heated, the active material supplying assembly 320 may be positioned above the heated roll such that the electro-active material 330 is simultaneously heated while being deposited on the substrate 310.

The substrate 310 may be a conductive substrate. The substrate 310 may be a conductive current collector. The current collector may be similar to current collectors 111 and 113. The substrate 310 may be a flexible conductive substrate (e.g., metallic foil or sheet). The substrate 310 may include a relatively thin conductive layer disposed on a host substrate comprising one or more conductive materials, such as a metal, plastic, graphite, polymers, carbon-containing polymer, composites, or other suitable materials. Examples of metals that the conductive substrate 310 may be comprised of include aluminum (Al), copper (Cu), zinc (Zn), nickel (Ni), cobalt (Co), palladium (Pd), platinum (Pt), tin (Sn), ruthenium (Ru), stainless steel, alloys thereof, and combinations thereof.

Alternatively, the substrate 310 may comprise a host substrate that is non-conductive, such as a glass, silicon, and plastic or polymeric substrate that has an electrically conductive layer formed thereon by means known in the art, including physical vapor deposition (PVD), electrochemical plating, electroless plating, and the like. The substrate 310 may be a separator. The separator may be similar to separator 115. In one embodiment, the substrate 310 is formed from a flexible host substrate. The flexible host substrate may be a lightweight and inexpensive plastic material, such as polyethylene, polypropylene, polyethylene terephthalate (e.g., Mylar) or other suitable plastic or polymeric material. A conductive layer may be formed over the non-conductive flexible host substrate. Alternately, the flexible substrate may be constructed from a relatively thin glass that is reinforced with a polymeric coating. In certain embodiments, the non-conductive flexible substrate is removable from the electrode structure.

The substrate 310 may have a thickness that generally ranges from about 1 to about 200 μm. The conductive substrate 310 may have a thickness that generally ranges from about 5 to about 100 μm. The conductive substrate 310 may have a thickness that ranges from about 10 μm to about 20 μm.

The substrate 310 may be patterned to form a three dimensional structure. Patterning of the substrate 310 may increase the adhesion of the electro-active material 330 to the surface of the substrate 310. The substrate 310 may be patterned or textured using the binder deposition source prior to deposition of powder onto the surface of the substrate 310. Other methods for preparing the surface of the substrate before construction of the electrode may be considered in conjunction with aforementioned processes, such as texturing the substrate 310 with an electromagnetic energy source, a nanoimprint lithography process, or an embossing process.

The substrate 310 may be heated prior to deposition of the electro-active material 330. The electro-active material 330 may be heated to a temperature just below the boiling temperature of the dispersant or solvent using an additional heat source, to encourage binding agent dispersion in the powder bed and to increase the dispersant or solvent drying rate after binder deposition.

The active material supplying assembly 320 may comprise any mechanism capable of depositing the electro-active material 330 onto the substrate 310. The active material assembly 320 may comprise a plurality of dispensing nozzles. Although three dispensing nozzles 322a-c are shown in FIG. 2A and three dispensing nozzles 322d-f are shown in FIG. 2B, any number of dispensing nozzles may be included. To achieve desired coverage of the current collector or substrate, each dispensing nozzle 322a-f of the active material assembly 320 may be independently translatable and/or the current collector or substrate may be translated relative to the active material assembly 320. Exemplary active material supplying assemblies include, but are not limited to sifters, electrostatic sprayers, thermal or flame sprayers, fluidized bed coaters, slit coaters, roll coaters, inkjet printers, three dimensional printers and combinations thereof, all of which are known to those skilled in the art. The electro-active material 330 may be applied using dry application techniques or wet application techniques. The material may be applied by powder application techniques including but not limited to sifting techniques, electrostatic spraying techniques, thermal or flame spraying techniques, fluidized bed coating techniques, slit coating techniques, roll coating techniques, 3DP techniques, and combinations thereof, all of which are known to those skilled in the art.

In certain embodiments, where thermal or flame spraying techniques are used, the “feedstock” (coating precursor) is heated by electrical (e.g., plasma or arc) or chemical means (e.g., combustion flame). The electro-active material 330 is fed in powder form, heated to a molten or semi-molten state and accelerated towards the substrate 310 in the form of micrometer-size particles. Combustion or electrical arc discharge is usually used as the source of energy for thermal spraying.

As previously discussed, the electro-active material 330 may include a single component such as an electro-active material or a mixture of components, such as an electro-active material, an electro-conductive material, a drying agent and a binding agent. The electro-active material 330 may be deposited in solid form, or as a liquid suspension where the dispersant is quickly evaporated leaving behind a well mixed and evenly dispersed powder.

The electro-active powder 330 may be in the form of nanoscale particles. The nanoscale particles may have a diameter between about 1 nm and about 100 nm. The particles of the powder may be micro-scale particles. The particles of the electro-active material 330 include aggregated micro-scale particles. The micro-scale particles may have a diameter between about 2 μm and about 15 μm. The electro-active material 330 may be coated with a carbon-containing material prior to deposition on the substrate 310.

The electro-active powder 330 may be combined with a carrying medium prior to application of the electro-active powder 330. In one embodiment, the carrying medium may be a liquid that is atomized before entering the processing chamber. The carrying medium may also be selected to nucleate around the electrochemical nanoparticles to reduce attachment to the walls of the processing chamber. Suitable liquid carrying media include water and organic liquids such as alcohols or hydrocarbons. The alcohols or hydrocarbons will generally have low viscosity, such as about 10 cP or less at operating temperature, to afford reasonable atomization. In other embodiments, the carrying medium may also be a gas such as helium, argon, nitrogen, or an aerosol in other embodiments. In certain embodiment, use of a carrying medium with a higher viscosity to form a thicker covering over the powder may be desirable.

A precursor or solid binding agent, typically a polymer, may be used to facilitate binding of the powder with the substrate 310. The solid binding agent may be blended with the electro-active material 330 prior to deposition on the substrate 310. The solid binding agent may be deposited on the substrate 310 either prior to or after deposition of the electro-active powder. The solid binding agent may comprise a flexible substance, such as a polymer, to hold the powder on the surface of the substrate. The binding agent will generally have some electrical or ionic conductivity to avoid diminishing the performance of the deposited layer, however most binding agents are usually electrically insulating and some materials do not permit the passage of lithium ions. In one embodiment, the binding agent is a carbon containing polymer having a low molecular weight. The low molecular weight polymer may have a number average molecular weight of less than about 10,000 to promote adhesion of the nanoparticles to the substrate. Exemplary binding agents include, but are not limited to, polyvinylidene difluoride (PVDF) and water-soluble binding agents, such as butadiene styrene rubber (BSR).

The deposition system 300 may be coupled to a power source 360 for supplying power to the various components of the deposition system 300. The power source 360 may be an RF or DC source. The power source 360 may be coupled with a controller 370. The controller 370 may be coupled with the deposition system 300 to control operation of the active powder supplying assembly 320. The controller 370 may include one or more microprocessors, microcomputers, microcontrollers, dedicated hardware or logic, and a combination of the same.

The deposition system 300 may be coupled with a fluid supply 365 for supplying precursors, processing gases, processing materials such as cathodically active particles, anodically active particles, binding agents, electro-conductive materials, propellants, and cleaning fluids to the components of the deposition system 300.

### EXAMPLES

The following hypothetical non-limiting examples are provided to further illustrate embodiments described herein. However, the examples are not intended to be all inclusive and are not intended to limit the scope of the embodiments described herein.

A slurry composition having 78 wt. % solid content and comprising 3 wt. % SBR, 6 wt. % carbon black (CB), and 91 wt. % nickel-manganese-cobalt was used for the following examples. An aluminum foil coupon was taped on a flat wafer surface for support. The wafer with the coupon positioned thereon was positioned over a hot plate.

### Example 1

The wafer and aluminum foil coupon were heated to and maintained at 80 degrees Celsius. The slurry composition was coated using a multi-layer hot doctor blade process. A coating having a 300 micron wet thickness was coated over the aluminum coupon at 50 microns/wet layer. The resulting dried coating had a thickness of 232 microns and an average porosity of 53%, which has approximately 6 mAh/cm² battery loading capacity.

### Example 2

The wafer and aluminum foil coupon were heated to and maintained at 120 degrees Celsius. The slurry composition was coated using a single layer hot doctor blade process. A coating having a 400 micron wet thickness was coated over the aluminum coupon using a single pass doctor blade process. The resulting dried coating had a thickness of 165 microns and an average porosity of 22%, which has approximately 6.5 mAh/cm² battery loading capacity.

### Example 3

The wafer and aluminum foil coupon were heated to and maintained at 120 degrees Celsius. The slurry composition was coated using a single layer hot doctor blade process. A coating having a 600 micron wet thickness was coated over the aluminum coupon using a single pass doctor blade process. The resulting dried coating had a thickness of 299 microns and an average porosity of 36%, which has approximately 10 mAh/cm² battery loading capacity.

### Example 4

The wafer and aluminum foil coupon were heated to and maintained at 120 degrees Celsius. The slurry composition was coated using a single layer hot doctor blade process. A coating having a 600 micron wet thickness was coated over the aluminum coupon using a single pass doctor blade process. The resulting dried coating had a thickness of 347 microns and an average porosity of 43%, which has approximately 10.5 mAh/cm² battery capacity loading.

Results:

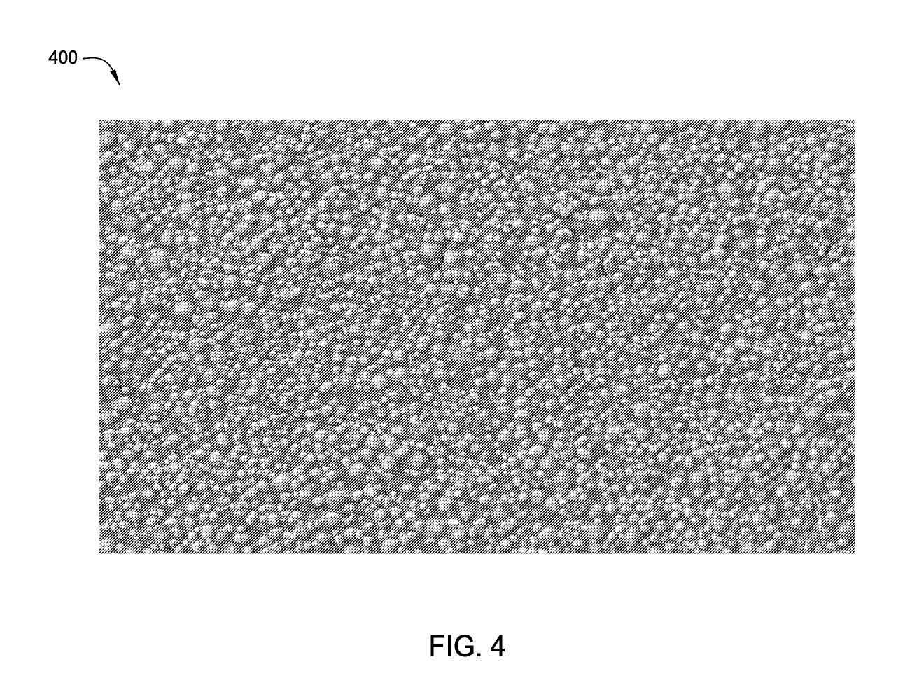

FIG. 4 is a schematic representation of a scanning electron microscope (SEM) image 400 at 200× magnification of one embodiment of cathode material deposited according to Example 3 described above. Typically it takes about 18 hours to completely dry an electrode of comparable thickness. For the cathode material shown in FIG. 4 deposited according to embodiments described herein drying of the surface was visible after 15 minutes. The surface of the cathode material shown in FIG. 4 was observed to be scratch-free.

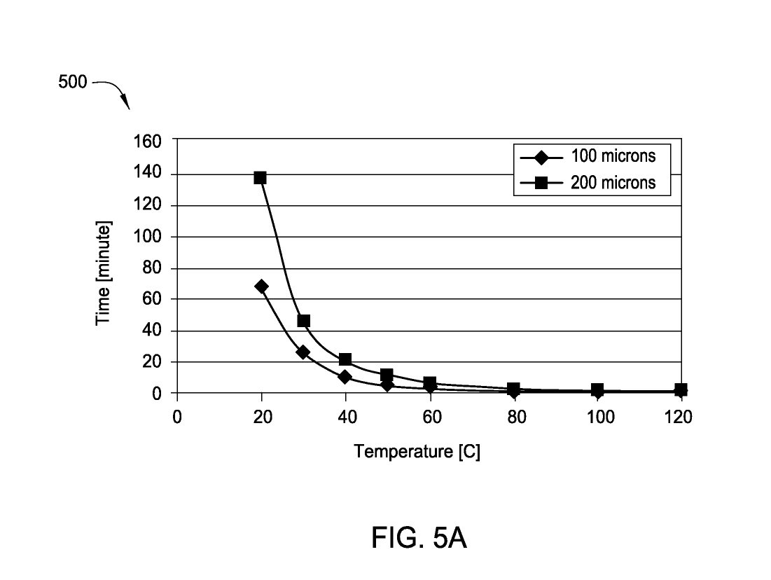

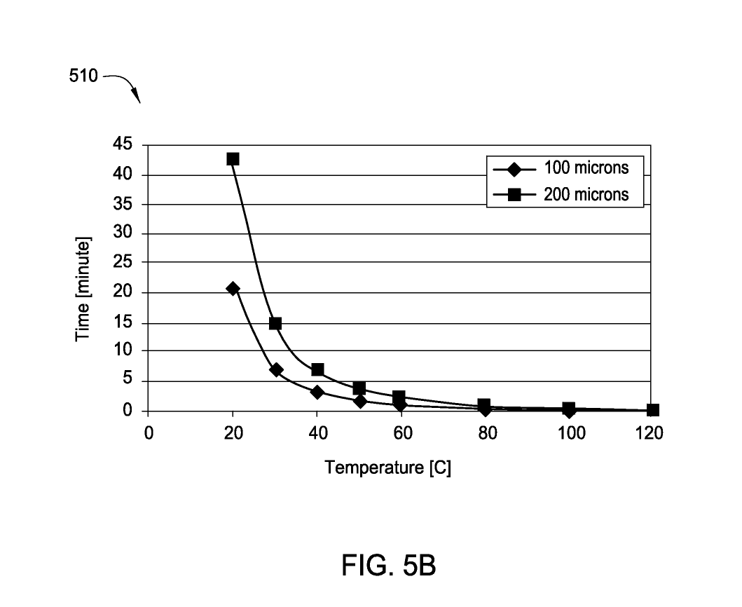

FIG. 5A is a plot 500 depicting simulated drying time for cathode materials having a thickness of 100 microns and 200 microns deposited in the presence of low flow rate air on coating surface. FIG. 5B is a plot 510 depicting simulated drying time for cathode materials having a thickness of 100 microns and 200 microns deposited in the presence of high flow rate air on coating surface. As the air flow increases, the drying time decreases.

While the foregoing is directed to embodiments of the present invention, other and further embodiments of the invention may be devised without departing from the basic scope thereof, and the scope thereof is determined by the claims that follow.

1. A deposition system for manufacturing energy storage electrodes comprising:
a transfer mechanism for transferring a substrate;
an active material supplying assembly having multiple dispensing assemblies for simultaneously depositing a plurality of different electrode forming materials onto the substrate from an electrode forming mixture; and
a heat source for simultaneously drying the electrode forming mixture as the electrode forming mixture is deposited onto the substrate.

2. The deposition system of claim 1, wherein the heat source is positioned below the transfer mechanism.

3. The deposition system of claim 2, further comprising:
a second heat source positioned above the transfer mechanism.

4. The deposition system of claim 1, wherein the heat source is positioned above the transfer mechanism to flow heated air over a surface of the current collector.

5. The deposition system of claim 4, wherein the heat source is configured to perform an air drying process, an infrared drying process, or an electromagnetic drying process.

6. The deposition system of claim 1, wherein the transfer mechanism comprises a roll-to-roll system with a common take-up roll and feed roll.

7. The deposition system of claim 6, wherein the take-up roll and the feed roll are each individually heated using an internal heat source positioned within each roll.

8. The deposition system of claim 1, wherein the active material supplying assembly is selected from sifters, electrostatic sprayers, thermal or flame sprayers, fluidized bed coaters, slit coaters, roll coaters, inkjet printers, three dimensional printers and combinations thereof.

9. The deposition system of claim 8, wherein the electrode forming mixture comprises an electro-active material, a binding agent, electro-conductive material, a drying agent, or combinations thereof.

10. The deposition system of claim 9, wherein the electro-active material comprises cathodically active particles selected from the group comprising lithium cobalt dioxide (LiCoO₂), lithium manganese dioxide (LiMnO₂), titanium disulfide (TiS₂), LiNixCo₁₋₂ₓMnO₂, LiMn₂O₄, iron olivine (LiFePO₄), LiFe₁₋ₓMgPO₄, LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, composites thereof and combinations thereof.

11. The deposition system of claim 9, wherein the electro-active material comprises anodically active particles selected from the group comprising graphite, graphene hard carbon, carbon black, carbon coated silicon, tin particles, copper-tin particles, tin oxide, silicon carbide, silicon (amorphous or crystalline), silicon alloys, doped silicon, lithium titanate, composites thereof and combinations thereof.

12. The deposition system of claim 1, wherein the electrode forming mixture is heated prior to deposition onto the substrate.

13. An electrode structure comprising:
a current collector; and
a plurality of multifunctional electrode layers vertically positioned relative to the current collector, wherein a portion of each of the multifunctional electrode layers contacts the current collector.

14. The electrode structure of claim 13, wherein each multifunctional electrode layer of the plurality of multifunctional electrode layers comprises cathodically active particles selected from the group comprising lithium cobalt dioxide (LiCoO₂), lithium manganese dioxide (LiMnO₂), titanium disulfide (TiS₂), LiNixCo₁₋₂ₓMnO₂, LiMn₂O₄, iron olivine (LiFePO₄), LiFe₁₋ₓMgPO₄, LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, composites thereof and combinations thereof.

15. The electrode structure of claim 13, wherein the current collector is aluminum foil.

16. The electrode structure of claim 13, wherein each of the multifunctional electrode layers varies from at least one of the other multifunctional layers in at least one of the following characteristics: materials, compositions/ingredient ratios, particle size, conductivity, porosity, energy/power grades, and combinations thereof.

17. An electrode structure comprising:
a current collector; and
a plurality of multifunctional electrode layers horizontally positioned relative to the current collector.

18. The electrode structure of claim 17, wherein each multifunctional electrode layer of the plurality of multifunctional electrode layers comprises cathodically active particles selected from the group comprising lithium cobalt dioxide (LiCoO₂), lithium manganese dioxide (LiMnO₂), titanium disulfide (TiS₂), LiNixCo₁₋₂ₓMnO₂, LiMn₂O₄, iron olivine (LiFePO₄), LiFe₁₋ₓMgPO₄, LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, composites thereof and combinations thereof.

19. The electrode structure of claim 18, wherein the current collector is aluminum foil.

20. The electrode structure of claim 17, wherein each of the multifunctional electrode layers varies from at least one of the other multifunctional layers in at least one of the following characteristics: materials, compositions/ingredient ratios, particle size, conductivity, porosity, energy/power grades, and combinations thereof.
